(19) United States
(12) Patent Application Publication
(10) Pub. No.: US 2012/0279065 A1
(43) Pub. Date: Nov. 8, 2012

(54) METHOD OF EXTRACTING BARREL NUTS

(75) Inventors: Mark Paul Elliott, Santa Barbara, CA (US); Aaron Kelly Wahlstrom, Tehachapi, CA (US)

(73) Assignee: Clipper Windpower, Inc.

(21) Appl. No.: 13/102,144

(22) Filed: May 6, 2011

(51) Int. Cl. B23P 6/00; B25B 27/14; B23P 11/00

(52) U.S. Cl. 29/889.1; 29/800; 29/705

(57) ABSTRACT

The present disclosure relates to a method for removing barrel nuts used for securing a plurality of studs to a turbine blade. Each stud is individually coupled to a respective barrel nut such that each barrel nut is anchored to a root end of the turbine blade. The barrel nut is heated to a predetermined temperature using a controller and a thermocouple. An adhesion between the barrel nut and the turbine blade is overcome and the barrel nut is extracted from the turbine blade. The barrel nut is removed from the turbine blade by connecting an extractor assembly or barrel nut removal device. This is accomplished from an interior surface of a root end of the turbine blade such that this method allows one to remove and replace barrel nuts while the turbine blade remains attached to the hub.

### BACKGROUND

The present exemplary embodiment relates to a method for extracting barrel nuts that are bonded in the root of a wind turbine blade. This disclosure finds particular application in conjunction with maintaining the blade root to hub mechanical connection of a wind turbine blade, and will be described with particular reference thereto. However, it is to be appreciated that the present exemplary embodiment is also applicable to other similar applications.

A typical utility-scale, horizontal axis wind turbine includes a set of rotor blades mounted to a hub. Two or three or possibly more blades could be used. The blades are aerodynamically designed to interact with the wind to generate a moment force and turn the hub. The hub and the blades together as an assembly (with other components) are typically referred to as the rotor. The rotor is connected to a main shaft and transfers torque to the main shaft, the main shaft may in turn be connected to a speed increasing gearbox that drives an electrical generator, or the main shaft can be directly connected to the electrical generator without a gearbox. The main shaft and its bearings, the gearbox, and the generator are typically mounted on a large base that is positioned inside of a nacelle assembly. The nacelle assembly forms a mostly enclosed structure around all of these machine parts. The nacelle assembly and machine base are typically mounted on top of a tower and can rotate, or yaw, relative thereto to align the rotor blades with the wind direction. Various different designs and topologies are, of course, possible for a wind turbine.

In many wind turbines, the rotor blade is mechanically attached to the hub via studs and barrel nuts. FIG. 2 shows the root end of a blade and the studs extending therefrom, ready to be bolted to a pitch bearing on the hub, or bolted directly to the hub.

The root end of the blade can form a relatively thin annular wall that extends from the root end towards the hub. The wall has an exterior annular surface, an interior annular surface and a circular end surface that connects the interior and exterior surfaces. The circular end surface is radially arranged around a central longitudinal axis of the blade, as seen in FIG. 2. The circular end surface abuts the hub when the rotor blade is mounted on the hub. A series of radially spaced bores for barrel nuts are drilled in a radial direction towards the central axis of the blade, through the exterior and interior surface of the annular wall. Each of the barrel nut bores intersects a stud bore formed normal thereto. The stud bores are drilled in an axial direction relative to the central axis of the blade, and penetrate the circular end surface of the root and terminate at the respective barrel nut bore.

Barrel nuts are positioned in the barrel nut bores. As is known, the barrel nuts have an internally threaded hole for a threaded connection to a stud. A stud is pushed through the respective stud bore and threaded to the barrel nut to firmly mechanically attach the studs to the root end of the blade.

From time to time, it may be necessary to remove and replace a barrel nut. The barrel nuts are often glued into position in the barrel nut bores and sealed by epoxy or other materials. This makes removal of the barrel nuts difficult.

One manufacturer of rotor blades recommends a process to heat the end of the barrel nut to be removed. The heat is used to loosen the epoxy material, allowing the barrel nut to be broken free and removed. More specifically, the process involves removing any sealant located around the exterior face and interior face of the barrel nut in the root end. A heater is then applied to the exposed ends of the barrel nut. A C-shaped clamping fixture spans the circular end surface of the root to engage the exterior surface and interior surface of the root end. The C-shape clamping fixture firmly holds a heating element in place against one or both of the exterior face and interior face of the barrel nut. In some instances, the heating element increases the temperature of the exterior or interior face of the barrel nut to a temperature higher than 90° C. to a maximum of approximately 320° C. to reduce the strength or adhesion of the surrounding epoxy. When the barrel nut and the surrounding epoxy is sufficiently heated and softened, the heating element and clamping fixture are removed. Then a second generally C-shaped fixture is employed to break the barrel nut free and force it out of the bore. The second fixture, like the first, spans the circular end surface to engage the interior and exterior surface of the root end. The fixture pushes against the interior end of the barrel nut, and clamps against the exterior surface of the root end, pushing the barrel nut out of its bore and out from the exterior surface. Of course, pushing in the opposite direction toward the interior and the central axis of the blade is also possible.

This existing method and these existing fixtures for removing barrel nuts work as long as the fixtures can span the blade end surface to engage the interior and exterior surfaces of the blade root. However, in some cases, it may be necessary to remove a barrel nut while the blade is attached to the hub, and in such a case, the existing method and fixtures will not work. In this case, the circular end surface abuts the hub and prevents the first and second C-shaped fixtures from engaging the interior and exterior surfaces of the root end. To use the existing method and C-shaped fixtures, the blade must be removed from the hub, and also preferably lowered to the ground. This requirement is a significant disadvantage.

Another disadvantage of the existing method is that the C-shaped fixtures are quite heavy and bulky, and difficult to hoist into position relative to the rotor blade which are also quite large.

Yet another disadvantage of the prior art method and assembly is that heating the exterior or interior face of the barrel nut requires a large amount of energy and heat to reduce the strength of the surrounding epoxy.

For the foregoing reasons, and others, there remains a need for an improved method and apparatus for efficiently removing barrel nuts used for securing studs to a rotor blade.

### BRIEF DESCRIPTION

In one embodiment, the present disclosure pertains to a method for removing barrel nuts used for securing studs to a turbine blade. The method includes connecting an extractor assembly connected to a barrel nut for mechanically securing a stud located about a root end of a turbine blade, the barrel nut being anchored to the root end of the turbine blade. The extractor assembly includes a structural body and a removal device having an internal heating element. The barrel nut is heated through the removal device to a predetermined temperature. The adhesion of the barrel nut to the turbine blade is overcome and the barrel nut is extracted from the turbine blade.

In another embodiment, the present disclosure pertains to a method of removing barrel nuts used for securing studs to a turbine blade while the turbine blade is attached to a hub. The method includes connecting a heating an removal device to the barrel nut while the barrel nut is secured to a root end of a turbine blade. The heating device includes a heating body having a first portion in thermal communication with the barrel nut. The barrel nut is simultaneously heated and extracted from the turbine blade and the attachment of the turbine blade to the hub is maintained.

In still another embodiment, provided is an apparatus for extracting barrel nuts used for securing studs to a turbine blade, the apparatus comprising a structural body for bracing between a barrel nut to be removed from a turbine blade and a removal device. The structural body including a closed end surface, an open end surface defining a cavity configured to accept said barrel nut. A heating element is operatively adapted to provide heat to the barrel nut. The removal device cooperates with the closed end surface opposite the open end surface of the body, the removal device being coupled to the barrel nut.

### BRIEF DESCRIPTION OF THE DRAWINGS

FIG. 1 is an plan view of a wind turbine assembly;

FIG. 2 is a perspective view of a root end of a rotor blade with a stud and barrel nut;

FIG. 3A is a cross sectional view of the root end of a rotor blade with a stud and barrel nut;

FIG. 3B is a cross sectional view of the root end of a rotor blade of FIG. 3A with the stud removed and a hole drilled in the barrel nut;

FIG. 3C is a perspective view of the root end of the rotor blade with a bolt extending from the root end, a barrel nut, and a first embodiment of an extractor assembly according to the present disclosure including a removal device and one embodiment of a means for moving the removal device;

FIG. 3D is a perspective view of another embodiment of a means for moving the removal device according to the present disclosure;

FIG. 4 is an enlarged cross sectional view of the extractor assembly of FIG. 3C with a barrel nut pulled into the assembly;

FIG. 5 is an exploded perspective view of the extractor assembly of FIG. 3;

### DETAILED DESCRIPTION

It is to be understood that the detailed figures are for purposes of illustrating exemplary embodiments only and are not intended to be limiting. Additionally, it will be appreciated that the drawings are not to scale and that portions of certain elements may be exaggerated for the purpose of clarity and ease of illustration.

In accordance with the present disclosure, a method is provided for maintenance of barrel nuts fixed in bores in a rotor blade of a wind turbine. The disclosed method is particularly related to the removal of a barrel nut 200 from a root end 120 of the wind turbine blade 140 so that it can be replaced with a new barrel nut.

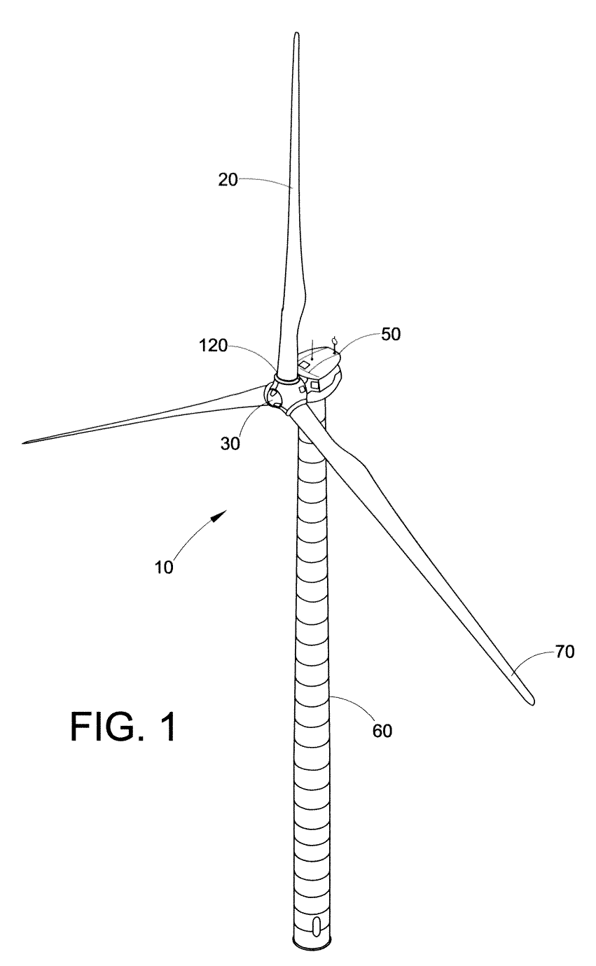

With reference to FIG. 1, a horizontal axis wind turbine 10 generally includes a set of rotor blades 20 which are mounted to a hub 30. The hub 30 and the blades 20 together as an assembly (with other components) are typically referred to as the rotor 40. The rotor 40 is connected to a main shaft and transfers torque to the main shaft such that an electric potential is created by a generator positioned inside of a housing 50 or nacelle assembly. The nacelle assembly forms an enclosure and is typically mounted on top of a tower 60 for increased interaction of wind with the rotor blades 20.

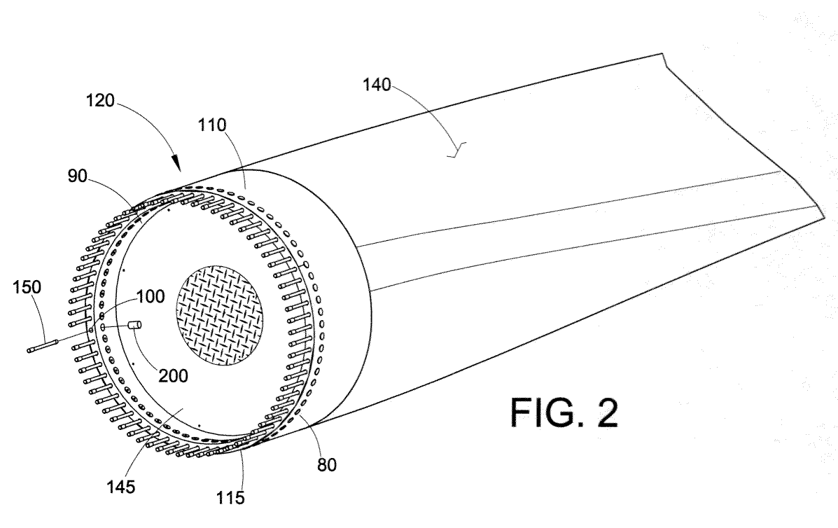

With reference to FIG. 2, the rotor blades 20 are mechanically attached to the hub 30 with a plurality of studs 150 and barrel nuts 200. The root end 120 of the rotor blade 140 and a plurality of studs 150 extending from a plurality of apertures 100 are ready to be bolted to a pitch bearing (not shown) on the hub 30, or bolted directly to the hub 30. The root end 120 of the blade 140 forms a relatively thin annular wall 110 that extends from the root end 120 towards a blade tip 70. The wall 110 has an exterior annular surface 80, an interior annular surface 90 and a circular end surface or rim 115 that extends between the interior surface 80 and the exterior surface 90 along the root end 120. The circular end surface 115 is radially arranged around a central longitudinal axis of the blade. The circular end surface 115 abuts the hub 30 when the rotor blade 140 is mounted on the hub 30. Notably, a vacant area 145 is circumscribed by the rim 115 of the blade 140 and defined by the interior annular surface 90.

The wind turbine blade 140 changes shape from the root end 120 toward the blade tip 70 until it assumes an air foil shaped configuration as illustrated in FIG. 1. The air foil shaped configuration continues to the blade tip 70. Root end 120 is designed to rigidly attach to a wind turbine hub 30. With reference now to FIG. 2, the plurality of spaced studs 150 extend away from the rim 115 of the blade root end 120. These are meant to be inserted into and fastened to the wind turbine hub 30 to form a mechanical connection between the rotor blade 140 and hub 30. In one embodiment, as many as sixty eight (68) apertures 100, studs 150 and barrel nuts 200 are spaced around the root end 120.

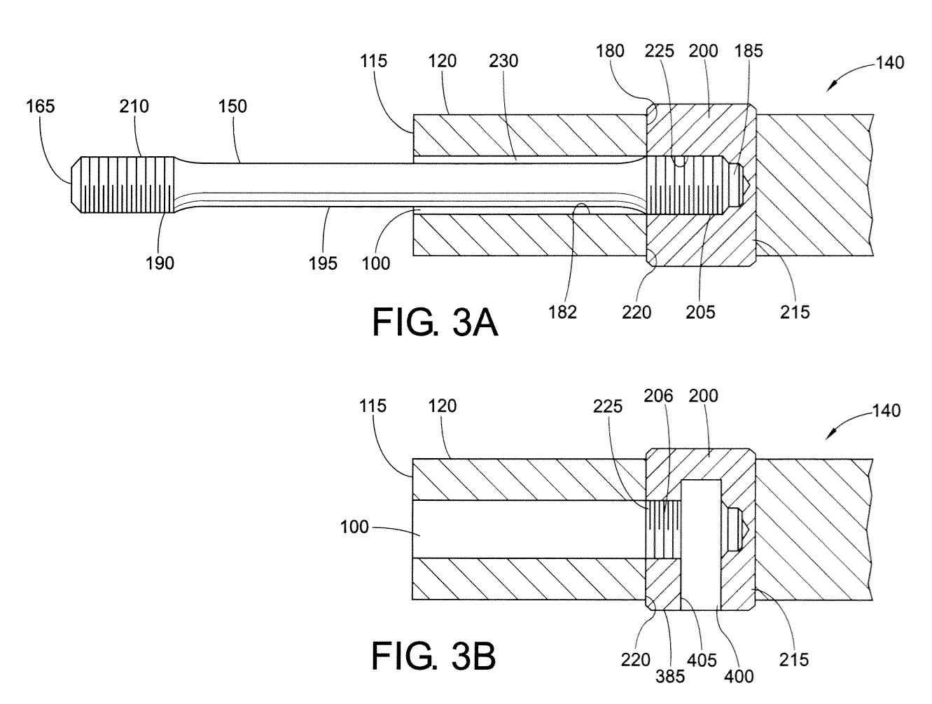

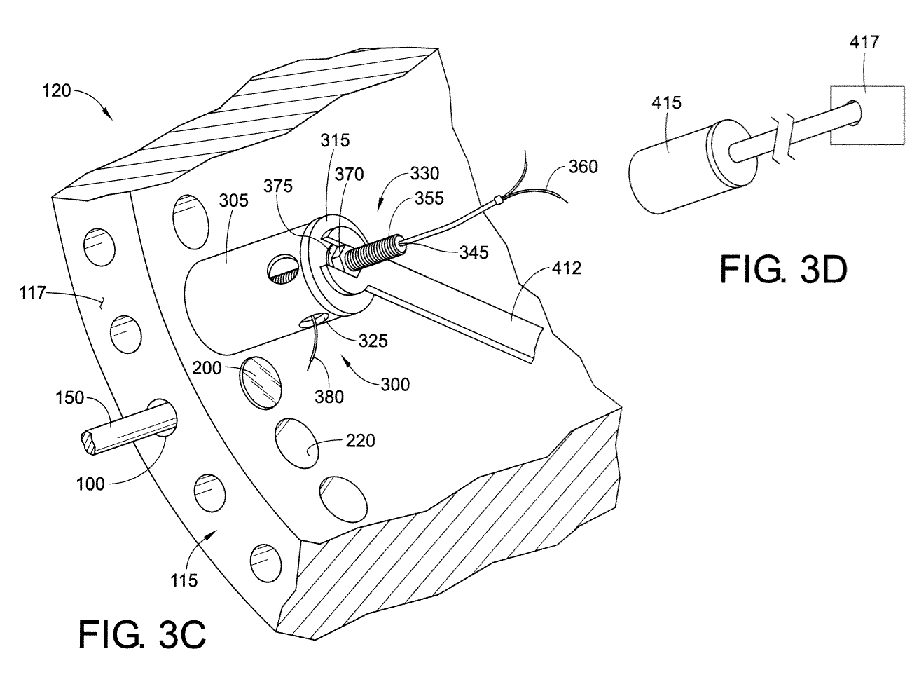

As shown in FIG. 3A, the stud 150 extends into the aperture 100 within the root end 120 of the blade 140. It should be apparent from FIG. 3A that the aperture 100 terminates at cross bore 180. Mounted in the cross bore 180 is the barrel nut 200. Stud 150 includes a distal or first end 185, a proximal or second end 190 and an intermediate portion 195. Intermediate portion 195 extends longitudinally between the distal end 185 and the proximal end 190. The distal end 185 of the stud 150 is engaged in the barrel nut 200. The intermediate portion 195 of the stud is spaced from an inner surface 182 of the aperture or bore 100. The distal end 185 is rigidly coupled to barrel nut 200 by a plurality of first threads 205. The proximal end 195 is also provided with a plurality of second threads 210 for coupling to the hub 30 of the wind turbine 10. A gap 230 exists between a side wall 182 of aperture 100 and intermediate portion 195. Barrel nut 200 is anchored to root end 120 of the turbine blade 140. In one embodiment, the barrel nut 200 comprises a generally cylindrical outer surface 215 that rigidly engages an adjacent wall surface 220 of the blade root end 120. Barrel nut 200 also includes an axial hole 225 to accommodate the distal end 185 of stud 150. Axial hole 225 may include threads 206 to receive first threads 205 of stud 150. An epoxy type compound can be provided between cylindrical outer surface 215 and engagement surface 220 to hold the barrel nut in place while axial hole 225 is aligned with axial aperture 100.

From time to time, it may be necessary to remove the barrel nut 200 for service, and potentially replace it with a new barrel nut. For example, when the internal threads 206 of the barrel nut 200 become damaged or due to mechanical or cyclic failure of the barrel nut 200 and stud 150 assembly. Other reasons why it may be necessary to replace a barrel nut include excessive corrosion, a defective barrel nut lot and lightning damage—as one barrel nut on each blade has a bolted connection to the blade or turbine lightning arrest system. Additionally, if the rotor blade 140 is attached to the hub 30, it is highly desirable to remove the barrel nut 200 from inside of the blade 140 and hub 30 only, without needing access to the outside surface of the blade 140. Otherwise, the whole blade 140 has to be removed from the hub 30 to remove and replace the barrel nut 200 and this is extremely expensive and time consuming.

As shown in FIGS. 3C, 4 and 5, one embodiment of an extractor assembly 300 is provided. Extractor assembly 300 comprises structural body 305 having a closed end surface 315 and an open end surface or base rim 320 defining a cavity 310. The cavity 310 is a substantially hollow interior that communicates with the open end surface. In one embodiment, the structural body 305 is cylindrically shaped. At least one side aperture 325 is positioned on structural body 305. A removal device, which in one embodiment can be a pull rod 330, can extend within hollow interior 310 and protrude through a top opening 335 in the closed end surface 315. Top opening 335 can be located concentrically along a common axis with cylinder body 305. Pull rod 330 can include shaft threads 355 located about an exterior surface of the pull rod 330. A substantially hollow interior 340 can be provided for the pull rod, with the interior having an open end 345 and a closed end 347 to allow for selective insertion of a heating element 350 connected to electrical wires 360. The wires 360 can allow electrical communication with a controller and a power source (not shown). Shaft threads 355 can be located adjacent o open end 345.

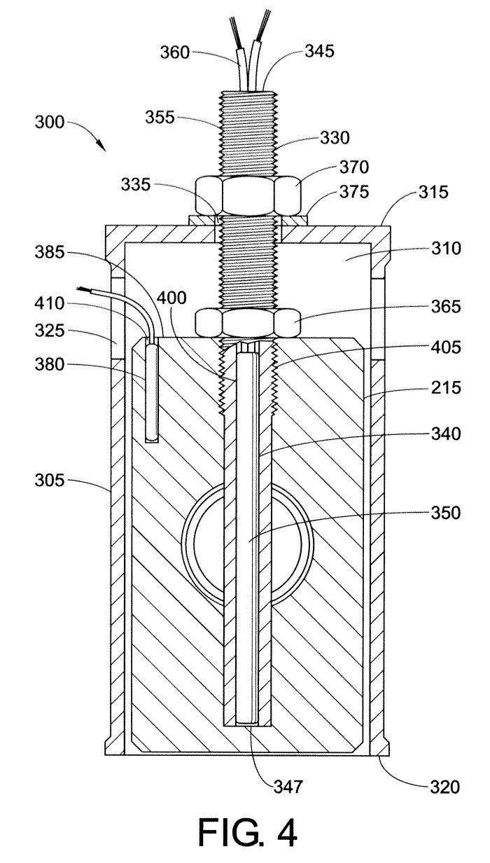

A locking nut 365, a torque nut 370 and torque washer 375 can be provided along shaft threads 355 of pull rod 330. Locking nut 365 is threadedly engaged to pull rod 330 and can be located within hollow interior 310 of cylindrical body 305, as shown in FIG. 4. Torque nut 370 and torque washer 375 engage shaft threads 355 outside of cylindrical body 305. Torque washer 375 can abut end surface 315 of the cylinder body 305 while torque nut 370 can abut torque washer 375. The torque nut 370 is threadedly engaged with pull rod 330. A thermocouple 380 can be provided through at least one side aperture 325 of cylinder body 305.

With reference now to FIG. 3C, to remove barrel nut 200, an associated worker prepares the area around barrel nut 200 by removing all residual sealant and nonconformities from both the barrel nut 200 and a surrounding area to achieve a generally clean surface. A clean surface is preferred for the proper engagement with the extractor assembly 300. Preparation may be accomplished by sanding or scraping the barrel nut and the surrounding area until the surface is suitable to support the extractor assembly 300. This is normally done to the interior surface 80 of the root end 120 because when the rotor blade 140 is mounted to the wind turbine 10, the interior surface 80 is accessible by an associated maintenance worker. This method is particularly advantageous when the barrel nut 200 is removed and replaced while the blade 140 is attached to the hub 30. Additionally, this method allows the associated maintenance worker to remove and replace the barrel nut 200 while the blade 140 and hub 30 are mounted to the wind turbine tower 60 hundreds of feet off of the ground.

With reference to FIGS. 3B and 4, after having determined that a barrel nut 200 is to be removed and preparing the surface thereon, in one preferred embodiment, the next step comprises drilling a bore hole 400 into an exposed surface 385 of the barrel nut 200 through at least a portion thereof. The hole could be a through hole, or a blind hole. The extractor assembly 300 is then connected to the barrel nut 200.

Bore hole 400 may generally be of any desired diameter and length, however, it should be appreciated that the bore hole 400 is sized such that at least a portion of shaft threads 355 of the pull rod are inserted within bore hole 400 to threadingly engage an inner surface 405 of bore hole 400. In one embodiment, the bore hole 400 extends along a common central axis of barrel nut 200. Further, the inner surface 405 of bore hole 400 can be tapped or threaded to firmly engage at least a portion of shaft threads 355. An optional second bore hole 410 may be drilled on exposed surface 385 through at least a portion of barrel nut 200 to house thermocouple 380. It should be appreciated that a length of bore hole 400 can be greater than a length of second bore hole 410.

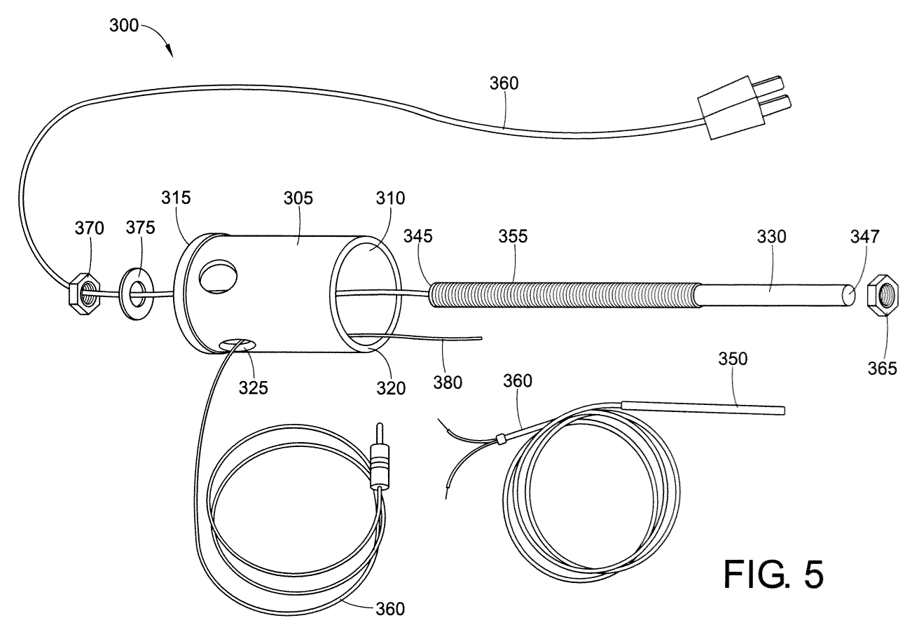

With reference again to FIG. 5, heating element 350 is inserted through torque nut 370, torque washer 375, and top opening 355 of cylindrical body 305, locking nut 365 and finally through open end 345 of pull rod 330. Heating element 350 can comprise an elongated cylindrical body having a diameter that allows sufficient surface area engagement with hollow interior 340 of pull rod 330. In one embodiment, high temperature grease is applied to heating element 350 and hollow interior 340 prior to insertion to assist in heat transfer. Further, heating element 350 extends within hollow interior 340 for a length substantially equal to a length that pull rod 330 is inserted into barrel nut 200 or to within 6 mm of closed end 347.

The closed end 347 of pull rod 330 is then inserted in bore hole 400 and at least a portion of shaft threads 355 engage inner surface 405. Locking nut 365 is axially tightened around pull rod 330 until locking nut 365 firmly abuts exposed surface 385. The locking nut 365 is provided to securely engage the pull rod 330 to the barrel nut 200. In one embodiment, high temperature grease is applied to pull rod 330 and inner surface 405 prior to insertion to assist in heat transfer. Further, in another embodiment, pull rod 330 is inserted no less than 4½″ (11.43 cm) through barrel nut 200.

Cylindrical body 305 is slid partially over pull rod 330 whereby base rim 320 abuts the root end 120 of the blade 140. Base rim 320 can have a diameter that is greater than a diameter of barrel nut 200 to allow barrel nut 200 to at least partially occupy hollow interior 310 when removed from root end 120. This is illustrated in FIG. 4. Torque washer 375 is provided on pull rod 330 and abuts end surface 315 of cylindrical body 305. Torque nut 370 is then provided on pull rod 330 and abuts torque washer 375. Thermocouple 380 is inserted through one of side apertures 325 and into second bore hole 410. A high temperature grease can be applied to thermocouple 380 and second bore hole 410 prior to insertion.

Both heating element 350 and thermocouple 380 are electronically connected to a controller and a power source (not shown). Heating element 350 is activated and provides consistent heat to barrel nut 200 until it reaches a predetermined temperature. In one embodiment, the temperature controller can be set to a value between 70° C. and 80° C., but preferably 75° C. A temperature profile readout is provided by thermocouple 380. When the temperature profile readout reaches approximately 70° C., a user can apply a tightening force to torque nut 370 thereby placing tension on barrel nut 200. The tightening force can be applied by a manually operated tool, such as a wrench 412. In one embodiment, the force applied is less than or equal to 100 ft-lbs (138.3 Newton-meters) of torque. The torque provided overcomes an adhesion of barrel nut 200 to root end 120. Once the barrel nut 200 begins to move, the torque nut 370 is rotated until barrel nut 200 is completely extracted. The heat provided may also cause longitudinal deformation of barrel nut 200 along a central axis thereby decreasing the width of barrel nut 200 and further adding to the ease of extracting barrel nut 200.

With reference now to FIG. 3D, another means for moving the pull rod is there illustrated. In this embodiment a hydraulic cylinder 415 is employed. The hydraulic cylinder communicates with a source of hydraulic fluid 417 held at a predetermined pressure. When pressurized fluid is applied, the hydraulic cylinder can be used to move the pull rod in a desired direction. In this embodiment, a hydraulic piston moves the barrel nut. A hydraulic pump is adapted to movably engage the piston thereby forcibly engaging barrel nut 200 and overcoming any adhesion between the blade and the barrel nut. The piston urges barrel nut away from the blade until it is completely extracted from the blade root end 120.

In one embodiment, barrel nut 200 can be 4½″ (12.07 cm) long. A diameter of bore hole 400 can be ½″ (1.27 cm). Further, the length of bore hole 400 can be 4½″ (11.43 cm) to allow for sufficient exposure of surface area between pull rod 330 and bore hole 400. In this embodiment, inner surface 405 can be threaded approximately 1″ (2.54) deep from exposed surface 385 of the barrel nut 200 for sufficient threaded engagement with pull rod 330. Additionally, second bore hole 410 can have a 1/16″ (0.42 cm) diameter for thermocouple 380. Notably, these measurements are approximations and other dimensions are also contemplated.

Disclosed has been a method of removing barrel nuts from a wind turbine blade 140 to maintain a sufficient mechanical connection between the root end 120 and a plurality of studs 150. The disclosed method allows removal of barrel nuts from a turbine blade while the blade remains mounted to the hub 30 or on an associate pitch bearing mounted to the hub 30, since access is only needed to the interior face of the turbine blade root end. Thus, the turbine blade can remain in a field service environment during the removal and maintenance of the barrel nut 200 and stud 150. Of course, it is also possible to remove barrel nuts 200 form a turbine blade 140 in a manufacturing environment.

The disclosure has been described with reference to the preferred embodiments. Obviously, modifications and alterations will occur to others upon reading and understanding the preceding detailed description. It is intended that the exemplary embodiments be construed as including all such modifications and alterations insofar as they come within the scope of the appended claims or the equivalents thereof.

1. A method for removing barrel nuts used for securing studs to a turbine blade, the method comprising:
connecting an extractor assembly to a barrel nut for securing a stud located about a root end of a turbine blade, the barrel nut being anchored to the root end of the turbine blade, the extractor assembly includes a cylinder body and a removal device having an internal heating element;
heating the barrel nut through the removal device to a predetermined temperature;
overcoming an adhesion of the barrel nut to the turbine blade; and
extracting the barrel nut from the turbine blade.

2. The method of claim 1, wherein heating the barrel nut to a predetermined temperature causes deformation of the barrel nut along a longitudinal axis thereof.

3. The method of claim 1, wherein the step of connecting the extractor assembly comprises drilling a bore hole in the barrel nut.

4. The method of claim 3, wherein the removal device includes a pull rod and the step of connecting the extractor assembly comprises positioning at least a portion of the pull rod in the bore hole and providing a locking nut to securely engage the pull bar to the barrel nut.

5. The method of claim 4, wherein the step of connecting the extractor assembly comprises:
aligning the cylinder body with the pull rod and barrel nut, the cylinder body including an end surface, and
securing the end surface to the pull rod.

6. The method of claim 5 further comprising rotating a torque nut in relation to the pull rod.

7. The method of claim 6 wherein the step of extracting the barrel nut includes manually moving the pull rod.

8. The method of claim 7, wherein the step of extracting the barrel nut includes applying a maximum of 100 ft-lbs of torque to the torque nut.

9. The method of claim 1, wherein the extractor assembly includes a thermocouple and further comprising drilling a bore hole adjacent an outer periphery of the barrel nut for placement of the thermocouple.

10. The method of claim 9, further comprising positioning at least a portion of the thermocouple in the bore hole.

11. The method of claim 9, further comprising providing a continuous temperature read out of a temperature profile of the barrel nut.

12. The method of claim 1, further comprising maintaining the blade attached to a hub while extracting the barrel nut from the turbine blade.

13. The method of claim 1 further comprising providing access to an interior surface of the turbine blade before the step of connecting the extractor assembly.

14. A method of removing barrel nuts used for securing studs to a turbine blade while the turbine blade is attached to a hub, the method comprising:
connecting a heating and removal device to the barrel nut while the barrel nut is secured to a root end of a turbine blade, said heating device including a heating body having a first portion in thermal communication with the barrel nut;
simultaneously heating and extracting the barrel nut from the turbine blade; and
maintaining the attachment of the turbine blade to a hub during the step of heating and extracting.

15. The method of claim 14, wherein the step of heating and extracting includes manually moving the heating and removal device.

16. The method of claim 14, further comprising providing access to an interior surface of the turbine blade before the step of connecting the heating and removal device.

17. An apparatus for extracting barrel nuts used for securing studs to an associated turbine blade, the apparatus comprising:
a structural body for bracing between a barrel nut to be removed from an associated turbine blade and a removal device, said structural body including a closed end surface and an open end surface defining a cavity configured to accept said barrel nut;
a heating element operatively adapted to provide heat to said barrel nut; and
said removal device cooperating with said closed end surface of said structural body, said removal device being coupled to said barrel nut.

18. The apparatus of claim 17, wherein the heating element is removably connected to the removal device.

19. The apparatus of claim 17 wherein said removal device comprises a pull rod cooperating with said body and at least one of a torque washer and a torque nut mounted to said pull rod and located adjacent said closed end surface of said body.

20. The apparatus of claim 17 wherein said removal device is coupled to the barrel nut while the turbine blade is attached to a hub.

21. The apparatus of claim 17 further comprising a thermocouple adapted to measure a temperature profile of said barrel nut.
